(19) United States
(12) Patent Application Publication
(10) Pub. No.: US 2015/0067387 A1
(43) Pub. Date: Mar. 5, 2015

(54) METHOD AND APPARATUS FOR DATA STORAGE

(71) Applicant: International Business Machines Corporation, Armonk, NY (US)

(72) Inventors: Zhihong Liao, Guangzhou (CN); Yi Yang, Shanghai (CN); Junwei Zhang, Shanghai (CN); Xin Zhang, Shanghai (CN)

(21) Appl. No.: 14/471,097

(22) Filed: Aug. 28, 2014

(30) Foreign Application Priority Data
Aug. 29, 2013 (CN) 201310384290.X

(51) Int. Cl. G06F 11/20

(52) U.S. Cl. CPC G06F 11/2094
USPC 714/6.3

(57) ABSTRACT

In response to detecting a failure on a secondary storage device, a transmission of a data write request to the primary storage device is suspended. Identifying an outstanding data write request, wherein the outstanding data write request has been performed by the primary storage device, but has not been performed by a disaster recovery (DR) storage device. Instructing the DR storage device to update data on the DR storage device according to the identified outstanding data write request. Setting the primary storage device to enable the primary storage device to forward a subsequently received data write request to the DR storage device. And restoring the transmission of the data write requests to the primary storage device.

### CROSS-REFERENCE TO RELATED APPLICATIONS

This application claims the benefit of priority from Chinese Patent Application Number 201310384290.X, filed Aug. 29, 2013, which is hereby incorporated by reference in its entirety.

### BACKGROUND

The present disclosure relates generally to computer technology, and more particularly, to a method and apparatus for data storage.

Large scale storage systems need significantly high reliability, primarily in two aspects: high availability (HA) and disaster recovery (DR). FIG. 2 shows a schematic diagram of a storage system having both high availability and the function of disaster recovery.

In FIG. 2, a primary storage device and a secondary storage device are located on a production site, which constitutes a server level data mirror to achieve high availability. Both the primary storage device and the secondary storage device are coupled to a production application server. All data write requests to the primary storage device are also sent to the secondary storage device, and only if both the primary storage device and the secondary storage device return a Production Site Write Success response, a data write request is considered as having been performed successfully. In this way, the primary storage device and the secondary storage device have identical data stored thereon. In a normal condition, the primary storage device is in charge of making responses to data read requests from the production application server. If the primary storage device fails, a switch is made to the secondary storage device for responding to data read requests from the production application server. Because the primary and secondary storage devices are located on the same site, the switch can be implemented rapidly, enabling high data availability on the site.

If production site breaks down totally, or if the primary storage device and the secondary storage device are out of service simultaneously for other reasons, a DR storage device is required. The DR storage device is located on another site separate from the production site, i.e., a DR site. In addition to the DR storage device, the DR site further comprises a DR production application server. If a failure occurs on the production site, the DR site is responsible for providing data externally.

The DR storage device and a storage device on the production site form a storage level data mirror. In FIG. 2, the DR storage device and the secondary storage device form a storage level data mirror. After a data write request is received by the secondary storage device, the data write request is performed locally, and is forwarded to the remote DR storage device. After the data write request is performed by the DR storage device, it transmits a DR Site Write Success response to the secondary storage device. After the DR Site Write Success response is received by the secondary storage device, the secondary storage device returns a Production Site Write Success response to the production application server.

The production site is generally separated from the DR site with a long distance, and an external network is required to couple the production site with the DR site. As compared with an internal network of the site, an external network has poor stability, lower data transmission rates, and thus is difficult to meet server-level data mirror requirements. Correspondingly, the server-level data mirror comprises only storage devices of the same site, which are coupled by an internal network of the site; while a storage-level data mirror is employed between the production site and the DR site, and external network connections are used between storage devices of different sites.

In a normal condition, in the structure shown in FIG. 2, data on the primary storage device, the secondary storage device and the DR storage device will be synchronous. However, if a failure occurs on the secondary storage device, in addition to the server-level data mirror, the storage-level data mirror fails as well, because data write requests cannot be forwarded to the DR storage device by the secondary storage device. In other words, some data write requests may be only performed by the primary storage device but not by the DR storage device. Correspondingly, data on the primary storage device and data on the DR storage device will turn into an asynchronous state. As a result, if the primary storage device fails later, the DR storage device cannot provide the updated data.

### SUMMARY

A method, system, and computer program product for data storage are provided in embodiments of the present disclosure, which are applicable to a storage system comprising a primary storage device, a secondary storage device, and a disaster recovery (DR) storage device, wherein the primary storage device and the secondary storage device constitute a server-level data mirror, and wherein the secondary storage device and the DR storage device constitute a storage-level data mirror. In response to detecting the failure on a secondary storage device, the transmission of a data write request to the primary storage device is suspended. Identifying an outstanding data write request, wherein the outstanding data write request has been performed by the primary storage device, but has not been performed by the DR storage device. Instructing the DR storage device to update data on the DR storage device according to the identified outstanding data write request. Setting the primary storage device to enable the primary storage device to forward a subsequently received data write request to the DR storage device. And restoring the transmission of the data write requests to the primary storage device.

According to various embodiments of the present disclosure, when there is a failure in the storage system, which causes the server-level data mirror and the storage-level data mirror out of service simultaneously, a data mirror relationship is established between a non-fault storage device of the server-level data mirror and a non-fault storage device of the storage-level data mirror, so that data on those non-fault storage devices are kept synchronized advantageously.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary computer system 10 which is applicable to implement the embodiments of the present disclosure;

FIG. 2 is a schematic diagram of a storage system to which an embodiment of the present disclosure is directed;

FIG. 3 is a schematic diagram of a method for data storage according to an embodiment of the present disclosure;

FIG. 4A and FIG. 4B are schematic diagrams of a storage system according to an embodiment of the present disclosure;

FIG. 5 is a flowchart of a method for data storage according to an embodiment of the present disclosure; and

FIG. 6 is a block diagram of an apparatus for data storage according to an embodiment of the present disclosure.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be coupled to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

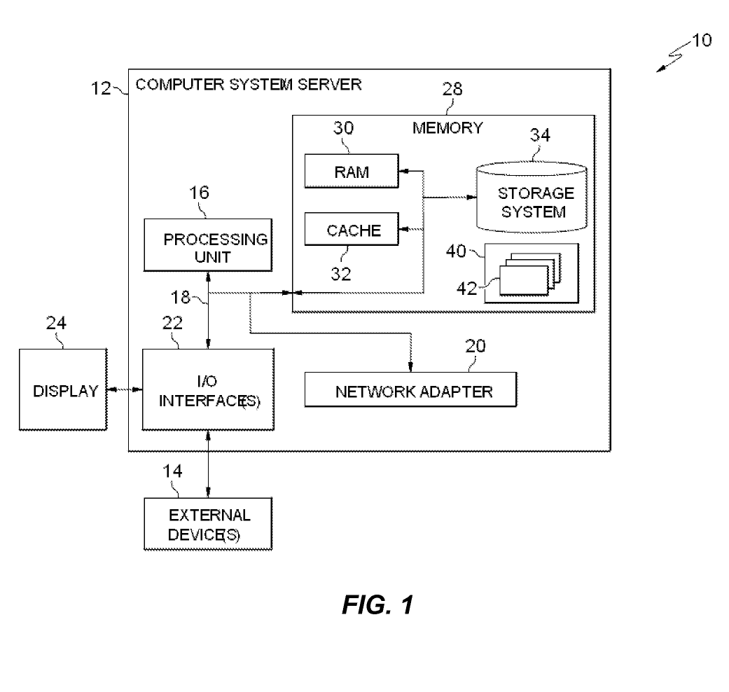

Referring now to FIG. 1, an exemplary computer system/server 12 which is applicable to implement the embodiments of the present disclosure is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be coupled to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

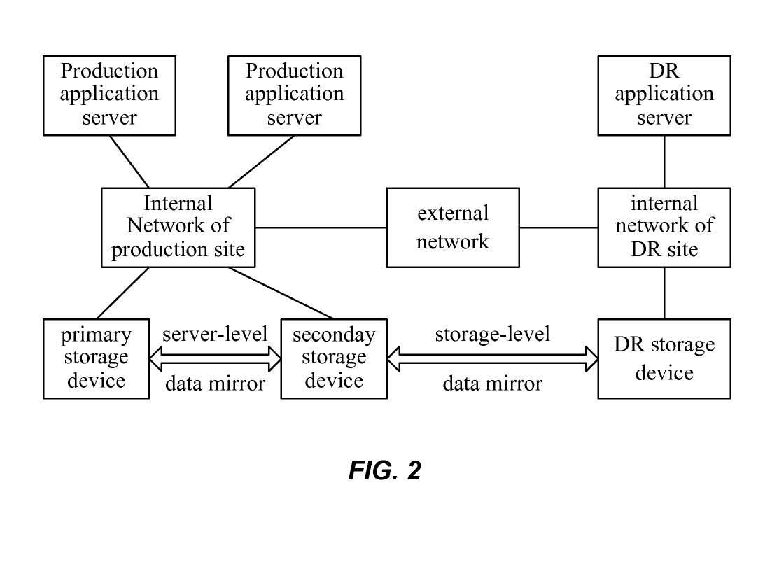

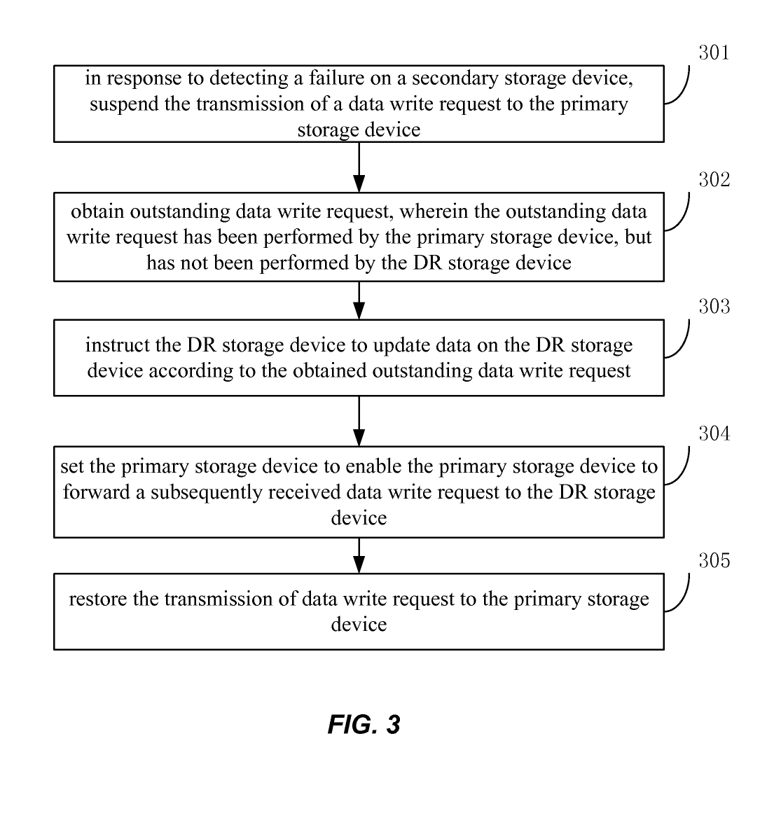

With reference now to FIG. 3, a method for data storage according to an embodiment of the present disclosure will be described. In the following description, reference will also be made to the system structure shown in FIG. 2. As shown in FIG. 2, the primary storage device and the secondary storage device constitute a server-level data mirror, wherein the secondary storage device refers to a storage device, which further constitutes a storage-level data mirror with a DR data mirror, and the other storage device is called the primary storage device. In general, in order to balance workloads on the primary storage device and the secondary storage device, one of the storage devices is responsible for constituting a storage-level data mirror with the DR data mirror, and the other storage device is responsible for responding to data read requests from the production application server in a normal condition. As desired, those skilled in the art may also have a storage device of the storage-level data mirror respond to data read requests from the production application server in a normal condition; then the storage device responding to data read requests from the production application server in a normal condition is the secondary storage device, according to the above definition.

At step 301, in response to detecting a failure of the secondary storage device, transmission of data write requests to the primary storage device is suspended.

According to an embodiment of the present disclosure, whether the secondary storage device has broken down may be detected by means of heartbeat signals. It is determined that the secondary storage device has failed if a new heartbeat signal is not detected during a predetermined period of time since the last heartbeat signal detected from the secondary storage device.

As described above, all data write requests to the primary storage device are also sent to the secondary storage device, and a data write request is considered as accomplished only after Production Site Write Success responses have been returned from the primary storage device and the secondary storage device respectively. Correspondingly, according to another embodiment of the present disclosure, it may be monitored whether a Production Site Write Success response has been received from the secondary storage device during a predetermined period of time since the data write request was sent to the secondary storage device. Alternatively, it may be monitored whether a Production Site Write Success response has been received from the secondary storage device during a predetermined period of time since a Production Site Write Success response has been received from the primary storage device. If no Production Site Write Success response from the secondary storage device is received, a failure of the secondary storage device is determined.

The secondary storage device and the DR storage device constitute a storage-level data mirror, and the data write request is forwarded to the DR storage device from the secondary storage device. In the case of a failure of the secondary storage device, the data write request cannot be forwarded to the DR storage device, causing out of sync of data on the primary storage device and data on the DR storage device. In a subsequent step, a storage-level data mirror relationship will be established between the DR storage device and the primary storage device to synchronize data on the DR storage device and data on the primary storage device. Those skilled in the art may understand that, before data synchronization, further changes to the data may increase the amount of work of data synchronization, and thus changes to the data on the primary storage device have to be suspended temporarily.

According to an embodiment of the present disclosure, data write instructions to be sent to storage devices may be temporarily buffered on the production application server. Those skilled in the art may understand that the transmission of data write requests to the primary storage device may be considered as having been suspended so long as data on the primary storage device does not change anymore.

At step 302, an outstanding data write request is identified, wherein the outstanding data write request has been performed by the primary storage device, but has not been performed by the DR storage device.

At step 302, after the actual occurrence of a failure on the secondary storage device, it may be detected only after a period of time. For example, in the case of heartbeat detection, in the worst case, a failure occurred on the secondary storage device may be detected after a period of one heartbeat signal since its actual occurrence on the secondary storage device. During this period, data write requests sent to the primary storage device are performed by the primary storage device, so that data on the primary storage device may be changed accordingly. However, some or all of these data write requests may not be forwarded to the DR storage device. Correspondingly, data on the DR storage device does not change as a result of performing these data write requests.

According to an embodiment of the present disclosure, for a data write request, depending on whether a Production Site Write Success response corresponding to the data write request has been received from the secondary storage device, it is determined whether the data write request has been performed by the DR storage device. As described above, after a data write request is forwarded to the DR storage device and is performed by the DR storage device, the DR storage device returns a DR Site Write Success response to the secondary storage device; after the DR Site Write Success response is received by the secondary storage device that constitutes a storage-level data mirror with the DR storage device, the secondary storage device may send a Production Site Write Success response. Hence, for a data write request, if a Production Site Write Success response is received from the primary storage device but no Production Site Write Success response is received from the secondary storage device, it may be considered that the data write request has been performed by the primary storage device but has not been performed the DR storage device.

At step 303, the DR storage device is instructed to update data on the DR storage device according to the identified outstanding data write request.

According to an embodiment of the present disclosure, the identified outstanding data write request may be sent to the DR storage device, and the DR storage device is instructed to execute the outstanding data write request. The outstanding data write request is received and then is performed by the DR storage device, so as to synchronize data on the DR storage device and data on the primary storage device.

According to another embodiment of the present disclosure, data on the primary storage device, which has been updated due to the accomplishment of the outstanding data write request may be sent to the DR storage device, and the DR storage device is instructed to replace corresponding old data with the updated data. The DR storage device replaces corresponding old data with the updated data to synchronize data on the DR storage device and data on the primary storage device.

A specific operation method will be further described with reference to other drawings later.

At step 304, the primary storage device is set to forward the subsequently received data write request to the DR storage device.

Information about the DR storage device may be stored in advance in respective storage devices constituting the server-level data mirror. Although information about the DR storage device is stored in the primary storage device, in a normal condition, the primary storage device does not forward data write requests to the DR storage device. If a failure on the secondary storage device has been detected by the primary storage device, the primary storage device may perform the configuration described above according to the stored information about the DR storage device by itself.

According to another embodiment of the present disclosure, information about the DR storage device may be stored in a storage controller. In response to detecting a failure on the secondary storage device, the storage controller sends a command containing the information to the primary storage device, to instruct the DR storage device to forward the subsequently received data write request according to the information.

At step 305, the transmission of data write requests to the primary storage device is restored.

According to the configuration at step 304, after a subsequent data write request is received by the primary storage device, it forwards the data write request to the DR storage device. Data on the DR storage device and data on the primary storage device have been synchronized in previous steps; and the primary storage device is configured to forward the subsequently received data write request to the DR storage device. In other words, any change to the data on the primary storage device may also happen to the data on the DR storage device. Thus, the primary storage device and the DR storage device constitute a storage-level data mirror. Even in the case of a failure occurred on the primary storage device later or a breakdown of the whole production site, a switch may be made to the DR site having synchronized data contained thereon to provide service externally.

According to an embodiment of the present disclosure, once a failure on the secondary storage device is detected, the configuration may be performed on the primary storage device and then the transmission of data write requests to the primary storage device may be restored, without waiting for the completion of the data synchronization at steps 302 and 303. If before forwarding a subsequent data write request to the DR storage device, the primary storage device determines that data has not been synchronized with the DR storage device, then the DR storage device is notified that data synchronization must be performed at first. After receiving the notification, the DR storage device buffers the subsequent data write request received and starts data synchronization with the primary storage device. After the completion of the data synchronization, the primary storage device notifies the DR storage device to start the execution of the subsequent data write request. The advantage of doing this is that the external network between the production site and the DR site is free during the time of identifying the outstanding data write request, which may be used to send a subsequent data write request to the DR storage device; upon the outstanding data write request is identified, resources of the external network may be allocated for data synchronization.

Those skilled in the art may understand, in order to enable data update of the DR storage device, the DR storage device must be informed by at least the following two contents: an identifier of a storage space to be updated, and data to be written to the storage space. According to an embodiment of the present disclosure, when performing data synchronization, at first, the identifier of the storage space to be updated may be sent to the DR storage device, and data to be written may be sent to the DR storage device in an asynchronous manner later.

In general, the time required by a storage device to completely recover from a failure state is usually in the order of magnitude of hours. After the occurrence of a failure on the secondary storage device, if data is not synchronized from the primary storage device to the secondary storage device and to the DR storage device until the recovery of the secondary storage device, data on the DR storage device may be out of sync with data on the primary storage device during the period up to hours. According to the technical solution of the present disclosure, data on the DR storage device may be synchronized with data on the primary storage device during a period of time in the order of magnitude of seconds.

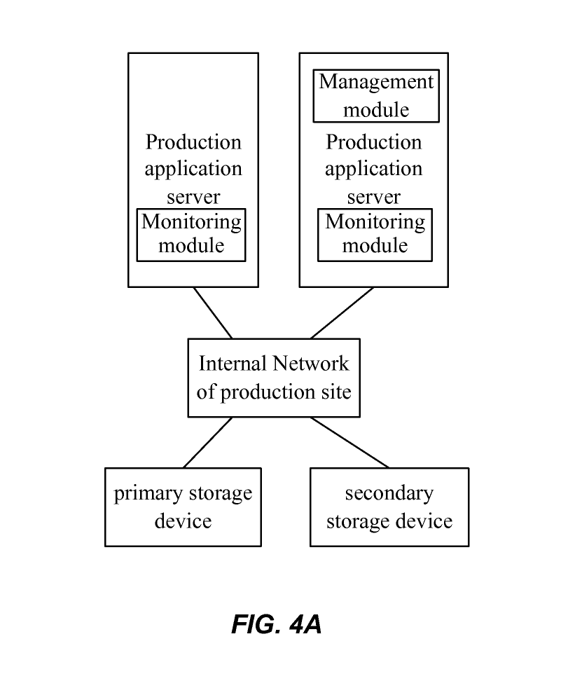

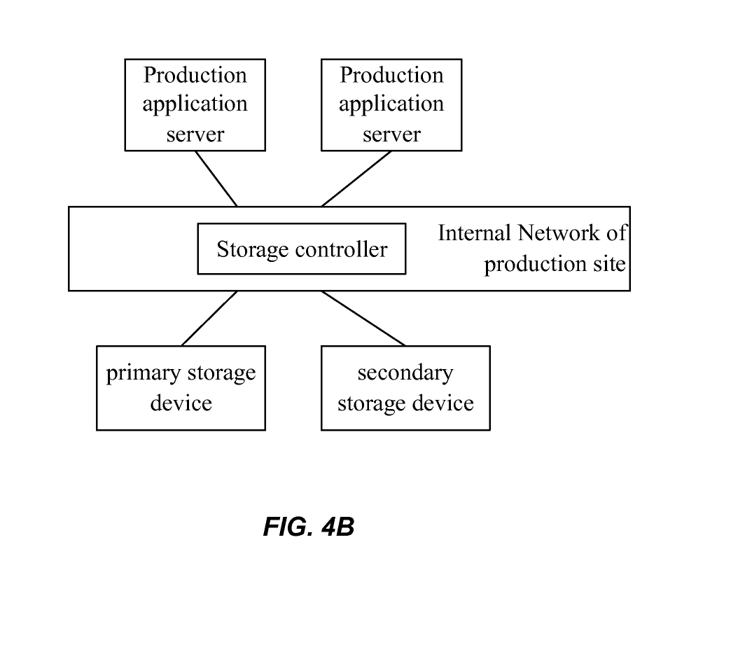

How to identify an outstanding data write request will be described below with reference to FIG. 4A and FIG. 4B.

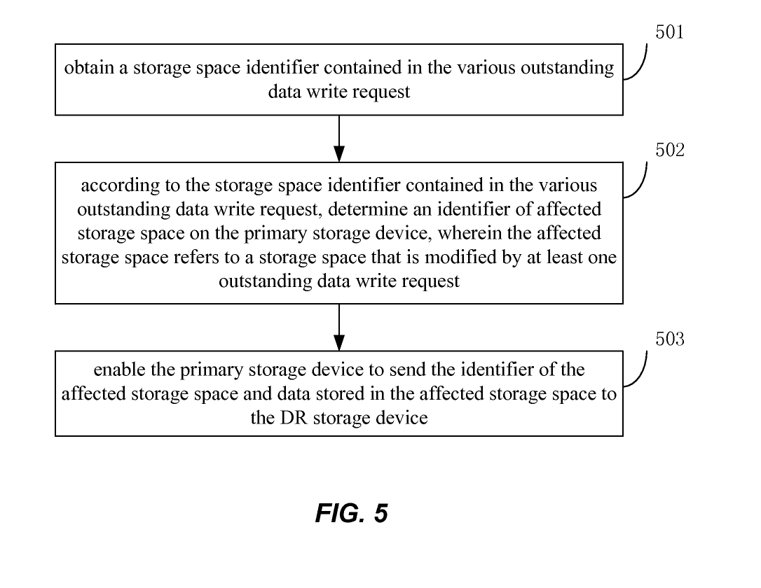

In the structure shown in FIG. 2, the production application server sends data write requests to storage devices and receives Production Site Write Success responses returned from storage devices. Each production application server may identify data write requests that are sent by the production application server and Production Site Write Success responses received correspondingly. According to an embodiment of the present disclosure, among data write requests that are sent by the server, an outstanding data write request may be made by each production application server. As shown in FIG. 4A, a monitoring module is provided on each production application server of the production site. For a data write request, if a Production Site Write Success response is received from the primary storage device, but no Production Site Write Success response is received from the secondary storage device, the data write request is recorded by the monitoring module. Determining outstanding data write requests by the production application server has higher efficiency. This is because the production application server generally has powerful computing capability; in addition, according to the embodiment of the present disclosure, each production application server determines respective outstanding data write requests in a distributed manner, causing a smaller workload increase to each production application server. One of the production servers may further comprise an management module. The management module will be described further with reference to FIG. 5.

According to another embodiment of the present disclosure, as shown in FIG. 4B, a storage controller may be provided between the production application servers and the storage devices. Data write requests that are sent from respective applications to the storage devices are at first sent to the storage controller and then are forwarded to the storage devices by the storage controller. Correspondingly, Production Site Write Success responses that are sent from respective storage devices to the production application servers are at first sent to the storage controller, and then are forwarded to the production application servers by the storage controller. Hence, the storage controller may identify all data write requests and each Production Site Write Success response for each data write request. Similarly, for a data write request, if a Production Site Write Success response is received from the primary storage device, but no Production Site Write Success response is received from the secondary storage device, the data write request is recorded by the storage controller.

As described above, according to the embodiment of the present disclosure, the identified outstanding data write requests may be sent to the DR storage device. The DR storage device receives and executes the outstanding data write requests to synchronize data on the DR storage device and data on the primary storage device. No matter whether outstanding data write requests are identified by the monitoring module on the production application server or the storage controller, those outstanding data write requests may be sent to the DR storage device through a network between the production site and the DR site. In general, it is not necessary to provide the function of communicating with the DR storage device for the production application server and the storage controller, while the storage devices have the function of communicating with each other. Thus, outstanding data write requests may be sent to the DR storage device through the primary storage device.

A method of updating data on the DR storage device according to another embodiment of the present disclosure will be described with reference to FIG. 5.

According to the embodiment of the present disclosure, data that is updated on the primary storage device due to the execution of the outstanding data write requests is sent to the DR storage device. The DR storage device replaces corresponding old data with the updated data to synchronize data on the DR storage device and data on the primary storage device.

At step 501, storage space identifiers contained in the respective outstanding data write requests are identified.

A data write request comprises at least two contents: an identifier of a storage space and data to be written. The storage space identifier indicates a segment of storage space in a storage device; the data to be written is data that will be written into the storage space. It should be understood that the length of the data to be written should match the length of the storage space. According to the embodiment of the present disclosure, a combination of a write address and a write length may be used as the storage space identifier, wherein the write address indicates the start address of the storage space, the write length indicates the length of the storage space, and thus a segment of storage space is determined uniquely. According to another embodiment of the present disclosure, a combination of a write start address and a write ending address may be used as the storage space identifier, wherein the write start address indicates the start address of the storage space, the write ending address indicates the ending address of the storage space, and thus a segment of storage space may be also determined uniquely. An outstanding data write request may involve multiple storage spaces.

At step 502, according to storage space identifiers of the respective outstanding data write requests, identifiers of affected storage spaces in the primary storage device are determined, wherein the affected storage space refers to a storage space that is modified by at least one outstanding data write request.

There may be multiple outstanding data write requests corresponding to the same storage space. Assume that a logic block is the smallest element of the storage space on the storage device. A preceding first outstanding data write request involves a first logic block (element), a second logic block and a fourth logic block on the primary storage device; a subsequent second outstanding data write request involves a second logic block, a fourth logic block and a eighth logic block on the storage device. Thus, on the primary storage device, storage spaces: the first, second, fourth and eighth logic blocks are affected by the two outstanding data write requests. Identifiers of the affected storage spaces may be generated using the method described above. Wherein, the second and fourth logic blocks are at first modified by the first outstanding data write request and then are modified by the second outstanding data write request.

At step 503, the primary storage device is enabled to send the identifier of the affected storage space and data stored in the affected storage space to the DR storage device.

In the above example, data stored in the first, second, fourth and eighth logic blocks are read out from the primary storage device. Wherein, data stored in the second and fourth logic blocks is the updated data that is modified twice by the first outstanding data write request and the second outstanding data write request.

According to the embodiment of the present disclosure, outstanding data write requests that are identified by respective production application servers are aggregated to identify identifiers of storage spaces on the primary storage device affected by the outstanding data write requests. This operation may be performed by a certain production application server, which may be called as an management production application server, in which the management module is included. Other production application servers coupled to the primary storage device in the production site send the respectively determined outstanding data write requests to the management production application server, which then determine identifiers of the affected storage spaces on the primary storage device. Then the management production application server sends the identifiers of the affected storage spaces and an associated instruction to the primary storage device, to enable the primary storage device to send the identifier of the affected storage space and data stored in the affected storage space to the DR storage device. After receiving the identifiers of the affected storage spaces and the instruction, the primary storage device identifies data stored in the affected storage spaces according to the identifiers. Then the primary storage device may construct a data update request, including the identifiers of the affected storage spaces and the data stored in the affected storage spaces. The primary storage device may send the data update request to the DR storage device in a format acceptable by the storage-level data mirror between the primary storage device and the DR storage device.

According to other embodiments of the present disclosure, the primary storage device may perform the management operation, and then send the identifier of the affected storage space and data stored in the affected storage space to the DR storage device. In this case, it is also necessary for production application servers or the storage controller to send the outstanding data write requests to the primary storage device, and instruct the primary storage device to send the identifier of the affected storage space and data stored in the affected storage space to the DR storage device.

As mentioned above, respective production application servers coupled to the storage devices may readily acquire which data write requests has been sent to the storage devices by themselves, and for which data write requests Production Site Write Success responses have been received. Thus, the efficiency of identifying outstanding data write requests by each storage device is higher than that of identifying outstanding data write requests by a storage controller. Similarly, as compared with performing the management operation by other nodes in the network, for example, the storage controller or the primary storage device per se, performing the management operation by one of the production application servers, i.e., management server, is more efficient. On the other hand, the primary storage device, just like the secondary storage device, has the capability of communicating with the DR storage device. Thus, the primary storage device may be used to send the identifiers of affected storage spaces and data stored in the affected storage spaces to the DR storage device.

With the method shown in FIG. 5, compared with sending the outstanding data write requests to the DR storage device, the traffic amount between the primary storage device and the DR storage device may be reduced. The data write request needs to indicate how to modify the storage space, i.e., comprising updated values of the storage space to be modified. If a first outstanding data write request and a second outstanding data write request are sent to the DR storage device separately, values of at least six logic blocks have to be sent to the DR storage device. As a comparison, because the storage spaces that are affected by the first outstanding data write request and the second outstanding data write request only comprise four logic blocks, it is only required to send values of the four logic blocks on the storage device to the DR storage device, so that network traffic may be saved.

Those skilled in the art may understand that a common production application server may not be provided with the capabilities of acquiring outstanding data write requests and aggregating multiple data write requests. In general, when coupling a production application server to a storage device, drivers may be provided for the production application server to provide the above capabilities for the production application server through running the drivers. Further, those skilled in the art may further understand that identifiers of storage spaces used on the production application servers and respective storage devices may be different, and thus conversion is required. How to convert storage space identifiers is common technical means in the art, which will not be described in detail herein.

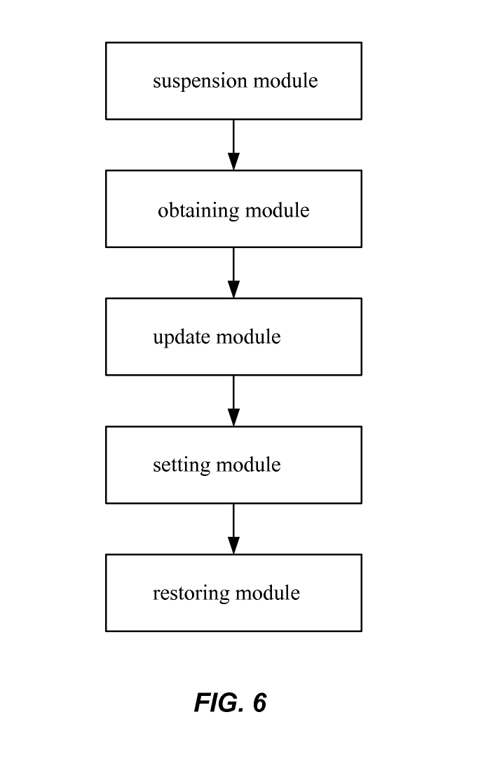

FIG. 6 shows a block diagram of an apparatus for data storage according to an embodiment of the present disclosure. The apparatus is applicable to a storage system comprising a primary storage device, a secondary storage device and a DR storage device, wherein the primary storage device and the secondary storage device constitute a server-level data mirror, and wherein the secondary storage device further constitutes a storage-level data mirror with the DR storage device. The apparatus may comprise a suspension module, configured to in response to detecting the failure on a secondary storage device, suspend the transmission of a data write request to the primary storage device; an identifying module, configured to identify an outstanding data write request, wherein the outstanding data write request has been performed by the primary storage device, but has not been performed by the DR storage device; an update module, configured to instruct the DR storage device to update data on the DR storage device according to the identified outstanding data write request; a setting module, configured to set the primary storage device to enable the primary storage device to forward subsequent data write requests to the DR storage device; and a restoring module, configured to restore the transmission of the data write request to the primary storage device.

The suspension module may comprise a module configured to, in response to not receiving a corresponding Production Site Write Success response from the secondary storage device after sending a data write request to the secondary storage device, suspend the transmission of data write request to the primary storage device.

The update module may comprise a module configured to send the identified outstanding data write request to the DR storage device to enable the DR storage device to receive and execute the outstanding data write request.

The update module may further comprise a module configured to send data that is updated due to the execution of the outstanding data write request on the primary storage device to the DR storage device, so as to enable the DR storage device to replace corresponding old data with the updated data.

The module configured to send data that is updated due to the execution of the outstanding data write request on the primary storage device to the DR storage device may comprise a module configured to identify a storage space identifier contained in the respective outstanding data write request; a module configured to, according to the storage space identifier contained in the respective outstanding data write request, determine identifier of affected storage space on the primary storage device, wherein the affected storage space refers to a storage space that is modified by at least one outstanding data write request; and a module configured to enable the primary storage device to send the identifier of the affected storage space and data stored in the affected storage space to the DR storage device.

The restoring module may comprise a module configured to, in response to data on the DR storage device that has not been updated according to the identified outstanding data write requests yet, instruct the primary storage device to notify the DR storage device that data synchronization is required at first, before forwarding the subsequently received data write request to the DR storage device.

The apparatus may be located on a production application server coupled to the storage system.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for data storage, applicable to a storage system comprising a primary storage device, a secondary storage device, and a disaster recovery (DR) storage device, wherein the primary storage device and the secondary storage device constitute a server-level data mirror, and wherein the secondary storage device and the DR storage device constitute a storage-level data mirror, the method comprising:
in response to detecting a failure on a secondary storage device, suspending the transmission of a data write request to the primary storage device;
identifying an outstanding data write request, wherein the outstanding data write request has been performed by the primary storage device, but has not been performed by the DR storage device;
instructing the DR storage device to update data on the DR storage device according to the identified outstanding data write request;
setting the primary storage device to enable the primary storage device to forward a subsequently received data write request to the DR storage device; and
restoring the transmission of the data write requests to the primary storage device.

2. The method according to claim 1, wherein in response to detecting a failure on a secondary storage device, suspending the transmission of a data write request to the primary storage device comprises:
in response to not receiving a corresponding Production Site Write Success response from the secondary storage device after sending a data write request to the secondary storage device, suspending the transmission of the data write request to the primary storage device.

3. The method according to claim 1, wherein updating data on the DR storage device according to the identified outstanding data write request comprises:
sending the identified outstanding data write request to the DR storage device to enable the DR storage device to receive and execute the outstanding data write request.

4. The method according to claim 1, wherein updating data on the DR storage device according to the identified outstanding data write request comprises:
sending data that is updated due to the execution of the outstanding data write request on the primary storage device to the DR storage device, so as to enable the DR storage device to replace corresponding old data with the updated data.

5. The method according to claim 4, wherein sending data that is updated due to the execution of the outstanding data write request on the primary storage device to the DR storage device comprises:
identifying a storage space identifier contained in the respective outstanding data write request;
according to the storage space identifier contained in the respective outstanding data write request, determining an identifier of affected storage space on the primary storage device, wherein the affected storage space refers to a storage space that is modified by at least one outstanding data write request; and
enabling the primary storage device to send the identifier of the affected storage space and data stored in the affected storage space to the DR storage device.

6. The method according to claim 1, wherein restoring the transmission of data write request to the primary storage device comprises:
in response to determining that data on the DR storage device has not been updated according to the identified outstanding data write requests, instructing the primary storage device to notify, before forwarding the subsequently received data write request to the DR storage device, the DR storage device that data synchronization is required at first.

7. The method according to claim 1, wherein the method is performed by a production application server coupled to the storage system.

8. A system for data storage, applicable to a storage system comprising a primary storage device, a secondary storage device, and a disaster recovery (DR) storage device, wherein the primary storage device and the secondary storage device constitute a server-level data mirror, and wherein the secondary storage device and the DR storage device constitute a storage-level data mirror, the system comprising:
one or more computer processors, one or more non-transitory computer-readable storage media, and program instructions stored on one or more of the non-transitory computer-readable storage media for execution by at least one of the one or more processors, the program instructions comprising:
program instructions, in response to detecting a failure on a secondary storage device, to suspend the transmission of a data write request to the primary storage device;
program instructions to identify an outstanding data write request, wherein the outstanding data write request has been performed by the primary storage device, but has not been performed by the DR storage device;
program instructions to instruct the DR storage device to update data on the DR storage device according to the identified outstanding data write request;
program instructions to set the primary storage device to enable the primary storage device to forward a subsequently received data write request to the DR storage device; and
program instructions to restore the transmission of the data write requests to the primary storage device.

9. The system according to claim 8, wherein the program instructions, in response to detecting a failure on a secondary storage device, to suspend the transmission of a data write request to the primary storage device comprises:
program instructions, in response to not receiving a corresponding Production Site Write Success response from the secondary storage device after sending a data write request to the secondary storage device, to suspend the transmission of the data write request to the primary storage device.

10. The system according to claim 8, wherein the program instructions to update data on the DR storage device according to the identified outstanding data write request comprises:
program instructions to send the identified outstanding data write request to the DR storage device to enable the DR storage device to receive and execute the outstanding data write request.

11. The system according to claim 8, wherein the program instructions to update data on the DR storage device according to the identified outstanding data write request comprises:
program instructions to send data that is updated due to the execution of the outstanding data write request on the primary storage device to the DR storage device, so as to enable the DR storage device to replace corresponding old data with the updated data.

12. The system according to claim 11, wherein the program instructions to send data that is updated due to the execution of the outstanding data write request on the primary storage device to the DR storage device comprises:
program instructions to identify a storage space identifier contained in the respective outstanding data write request;
program instructions, according to the storage space identifier contained in the respective outstanding data write request, to determine an identifier of affected storage space on the primary storage device, wherein the affected storage space refers to a storage space that is modified by at least one outstanding data write request; and
program instructions to enable the primary storage device to send the identifier of the affected storage space and data stored in the affected storage space to the DR storage device.

13. The system according to claim 8, wherein the program instructions to restore the transmission of the data write request to the primary storage device comprises:
program instructions, in response to determining that data on the DR storage device has not been updated according to the identified outstanding data write requests, to instruct the primary storage device to notify, before forwarding the subsequently received data write request to the DR storage device, the DR storage device that data synchronization is required at first.

14. The system according to claim 1, wherein the program instructions are performed by a production application server coupled to the storage system.

15. A computer program product for data storage, applicable to a storage system comprising a primary storage device, a secondary storage device, and a disaster recovery (DR) storage device, wherein the primary storage device and the secondary storage device constitute a server-level data mirror, and wherein the secondary storage device and the DR storage device constitute a storage-level data mirror, the computer program product comprising:
one or more non-transitory computer-readable storage media and program instructions stored on the one or more non-transitory computer-readable storage media, the program instructions comprising:
program instructions, in response to detecting a failure on a secondary storage device, to suspend the transmission of a data write request to the primary storage device;
program instructions to identify an outstanding data write request, wherein the outstanding data write request has been performed by the primary storage device, but has not been performed by the DR storage device;
program instructions to instruct the DR storage device to update data on the DR storage device according to the identified outstanding data write request;
program instructions to set the primary storage device to enable the primary storage device to forward a subsequently received data write request to the DR storage device; and
program instructions to restore the transmission of the data write requests to the primary storage device.

16. The computer program product according to claim 15, wherein the program instructions, in response to detecting a failure on a secondary storage device, to suspend the transmission of a data write request to the primary storage device comprises:
program instructions, in response to not receiving a corresponding Production Site Write Success response from the secondary storage device after sending a data write request to the secondary storage device, to suspend the transmission of the data write request to the primary storage device.

17. The computer program product according to claim 15, wherein the program instructions to update data on the DR storage device according to the identified outstanding data write request comprises:
program instructions to send the identified outstanding data write request to the DR storage device to enable the DR storage device to receive and execute the outstanding data write request.

18. The computer program product according to claim 15, wherein the program instructions to update data on the DR storage device according to the identified outstanding data write request comprises:
program instructions to send data that is updated due to the execution of the outstanding data write request on the primary storage device to the DR storage device, so as to enable the DR storage device to replace corresponding old data with the updated data.

19. The computer program product according to claim 18, wherein the program instructions to send data that is updated due to the execution of the outstanding data write request on the primary storage device to the DR storage device comprises:
program instructions to identify a storage space identifier contained in the respective outstanding data write request;
program instructions, according to the storage space identifier contained in the respective outstanding data write request, to determine an identifier of affected storage space on the primary storage device, wherein the affected storage space refers to a storage space that is modified by at least one outstanding data write request; and
program instructions to enable the primary storage device to send the identifier of the affected storage space and data stored in the affected storage space to the DR storage device.

20. The computer program product according to claim 15, wherein the program instructions to restore the transmission of the data write request to the primary storage device comprises:
program instructions, in response to determining that data on the DR storage device has not been updated according to the identified outstanding data write requests, to instruct the primary storage device to notify, before forwarding the subsequently received data write request to the DR storage device, the DR storage device that data synchronization is required at first.
